(19) United States
(12) Patent Application Publication
(10) Pub. No.: US 2012/0292409 A1
(43) Pub. Date: Nov. 22, 2012

(54) NOZZLE

(75) Inventors: Edgar Bignion, Le Paquier (CH); Waldemar Hampel, Bulle (CH); Walter Meindl, Hafenberg (AT); Werner Aichberger, Altenberg (AT)

(73) Assignee: Liebherr Machines Bulle SA, Bulle (CH)

(21) Appl. No.: 13/472,881

(22) Filed: May 16, 2012

(30) Foreign Application Priority Data
May 16, 2011 (CH) 00824/11

(51) Int. Cl. B05B 1/00; B23P 17/00; F02M 63/00

(52) U.S. Cl. 239/533.2; 239/589; 29/890.09

(57) ABSTRACT

The present invention concerns a nozzle with a nozzle body on the back of which a blind hole or seat hole is realized, whereby at least one spray hole leads outward from the blind hole or seat hole, in such a way that the spray hole displays a non-round cross section in the area of the spray hole aperture.

### BACKGROUND OF THE INVENTION

The present invention concerns a nozzle with a nozzle body on the back of which a blind hole or seat hole is realized, whereby at least one spray hole leads outward from the blind hole or seat hole. The present invention concerns particularly a fuel injector nozzle for the injection of fuel in combustion engines.

In the state of the art, nozzles with a dome-shaped elevation as nozzle body are known, on the back of which the cylindrical or conical blind hole or seat hole is realized. From this several spray holes generally extend radially outward to the perimeter of the elevation. The spray holes are generally realized as cylindrical bores.

### SUMMARY OF THE INVENTION

The purpose of the present invention is, on the basis of this state of the art, to provide a nozzle which displays improved fatigue strength, especially in the area of the spray hole entrance.

This purpose is accomplished independently in each case by a nozzle according to the description herein.

A nozzle according to the first aspect of the present invention displays a nozzle body on the back of which a blind hole or seat hole is realized, whereby at least one spray hole leads outward from the blind hole or seat hole. It is thereby provided that the spray hole in the area of the spray hole entrance displays a non-circular cross section. The non-circular cross section thus permits a targeted orientation of the forces acting on the spray hole and the nozzle body. By the spray hole entrance is meant the end of the spray hole adjoining the blind hole or seat hole, by which a fluid flowing through the nozzle enters the spray hole from the blind hole or seat hole.

The spray hole advantageously displays in the area of the spray hole entrance a cross section with a longer and a shorter axis of symmetry, e.g. an oval cross section. This is advantageously an elliptical cross section.

Also advantageously, the spray hole displays a circular cross section in the area of the spray hole exit. By this means the usual spray cone of the spray exiting the nozzle is obtained. By the spray hole exit is meant the end of the spray hole oriented away from the blind hole or seat hole, through which a fluid flowing through the nozzle exits the spray hole.

The first aspect of the present invention is advantageously used with nozzles displaying several spray holes which lead outward from the blind hole or seat hole, whereby several or all of the spray holes display a non-circular cross section in the area of the spray hole entrance.

The non-circular cross sections of all the blind holes advantageously display the same orientation with regard to the long axis of the blind hole or seat hole. In particular, the short or long axes of symmetry of all the spray holes are all oriented in the same way with regard to the long axis of the blind hole or seat hole.

Also advantageously, the long axis of the non-circular cross section, in particular the long axis of the ellipse, is oriented parallel or perpendicular to the long axis of the blind hole or seat hole.

By means of the non-circular form of the spray hole entrance, the long axis of the spray hole entrance can be oriented in accordance with the stress acting on the nozzle body, whereby the cross section of the spray hole does not fall short of the required minimum cross section.

With dominant circumferential stress in the blind hole or seat hole, the long axis is horizontally disposed, i.e. in a plane perpendicular to the long axis of the blind hole or the seat hole. By this means a lesser notch effect arises in the direction of the load than with a circular cross section. With dominant axial stress in the blind hole or seat hole, in contrast, the long axis of the spray hole entrance is vertically disposed, i.e. in a plane running parallel to the long axis of the blind hole or seat hole. Also by means of this arrangement a lesser notch effect in the load direction can be attained than with the use of a circular cross section for the spray hole entrance.

According to a second aspect of the present invention, the nozzle comprises a nozzle body on the back of which a blind hole or seat hole is realized, whereby several spray holes lead outward from the blind hole or seat hole. According to the invention it is provided that the blind hole or seat hole displays a groove out of which the spray holes lead. By disposing the spray hole entrances in the area of a groove on the interior of the blind hole or seat hole, the notch effect which arises with conventional intersecting bores can likewise be reduced.

It is advantageous to provide that the groove is disposed so as to be rotationally symmetrical with regard to the long axis of the blind hole or seat hole.

It can further be provided that the spray holes are disposed at the same level with regard to the blind hole axis. The width of the groove in the direction of the long axis of the blind hole or seat hole is advantageously greater than the diameter of the spray holes.

It can further be provided that the spray holes are regularly distributed on the circumference of the groove, i.e. that the same distance is provided between individual spray holes.

A nozzle according to a third aspect of the present invention displays a nozzle body on the back of which a blind hole or seat hole is realized, whereby at least one spray hole leads outward from the blind hole or seat hole. According to the invention, it is thereby provided that the spray hole at the spray hole exit, is widened by a counterbore. This makes it possible to increase the thickness of the wall along the axis of the spray hole, without increasing the length of the spray hole. This also leads to increased fatigue strength, in particular at the spray hole entrance.

The counterbore is advantageously realized so as to be rotationally symmetrical to, the axis of the spray hole. The counterbore is in particular advantageously U-shaped, so that the geometry of the spray cone leaving the spray hole is less affected.

The three aspects of the present invention permit in and of themselves an increase in the fatigue strength of a nozzle, in particular a fuel injection nozzle. The individual aspects can also be combined.

In particular, the first aspect of the present invention can be combined with the second and/or third aspect. Also advantageously, the second aspect can be combined with the first or third aspect. Likewise, the third aspect can be combined with the first and/or second aspect.

All aspects of the present invention are preferentially deployed with nozzles, as specified below:

The nozzle can display several spray holes which lead outward from the blind hole or seat hole. In particular more than three spray holes, or more advantageously more than six spray holes, are provided. The long axes of the spray holes advantageously run radially outward at an acute angle to the long axis of the blind hole or seat hole.

It can further be advantageously provided that the nozzle body is made rotationally symmetrical. The blind hole or seat hole can also be made rotationally symmetrical. Several spray holes are thereby advantageously provided, which are disposed regularly and circumferentially around the long axis of the nozzle body or the blind hole or seat hole, i.e. with equal distances around the circumference.

The nozzle body can furthermore display an elevation, on the back of which the blind hole or seat hole is realized, whereby several spray holes lead radially outward from the blind hole or seat hole to the perimeter of the elevation. In particular, the elevation can be dome-shaped.

According to the invention, several spray holes are thereby provided; thus these are advantageously identically realized.

As described above, the nozzle pertains in particular to a fuel injection nozzle for the injection of fuel into a combustion engine. With direct injection engines in particular, very high pressures are applied, so that the increased fatigue strength of the nozzle provided by the present invention is a particular advantage.

In addition to the nozzle, the present invention further comprises a combustion engine with such a nozzle for the injection of fuel. In particular this nozzle can serve for the direct injection of fuel into the cylinder.

In addition to the nozzle itself, the present invention further comprises a process for the production of a nozzle according to the first aspect of the present invention. According to the invention the non-circular cross section of the spray hole in the area of the spray hole entrance is produced with an erosion wire, which during the production of the spray hole wears a path in the space corresponding to the non-circular cross section of the spray hole.

Advantageously, during the production of the nozzle by appropriate control of the erosion wire apparatus, a defined path in the space is worn by the erosion wire, which produces the spray hole according to the first aspect of the present invention. The path can be advantageously chosen as desired not only in a plane but also in depth.

The use of an erosion wire thus makes it possible to cut the specific cross section of the spray hole out of the material of the nozzle body in the area of the spray hole entrance and as necessary in the area of the spray hole exit.

The nozzle according to the invention is made advantageously of metal.

### BRIEF DESCRIPTION OF THE DRAWINGS

The present invention will now be specified by means of embodiments and drawings.

These show:

FIG. 1: a first embodiment of the first aspect of the present invention,

FIG. 2: a second embodiment of the first aspect of the present invention,

FIG. 3: an embodiment of the second aspect of the present invention, and

FIG. 4: an embodiment of the third aspect of the present invention.

### DESCRIPTION OF THE PREFERRED EMBODIMENTS

For the sake of clarity, the three aspects of the present invention are described individually by means of examples below. However, two of the aspects or all three aspects combined together are preferred.

All embodiments of the present invention display a nozzle with a nozzle body 5, on the back of which a blind hole or seat hole 1 is realized. From the blind hole or seat hole 1 several spray holes 2 extend outward. The spray holes 2 are oriented with their spray hole entrances 3 toward the blind hole or seat hole, while the spray hole exits 4 indicate the exterior of the nozzle body 5.

The nozzle body 5 displays an elevation in the area of the blind hole or seat hole 1, in which the blind hole or seat hole is realized. The elevation 5 is essentially dome-shaped in the area of the blind hole or seat hole 1. Both the elevation 5 and the blind hole or seat hole 1 are rotationally symmetrical in the embodiment.

The spray holes 2 run from the side wall of the blind hole or seat hole 1 radially outwards to the perimeter of the nozzle body 5. The long axes of the spray holes 2 display vertically an acute angle with the long axis of the blind hole or seat hole 1 or the nozzle body 5. The spray holes 2 are regularly disposed on the perimeter around the blind hole or seat hole 1.

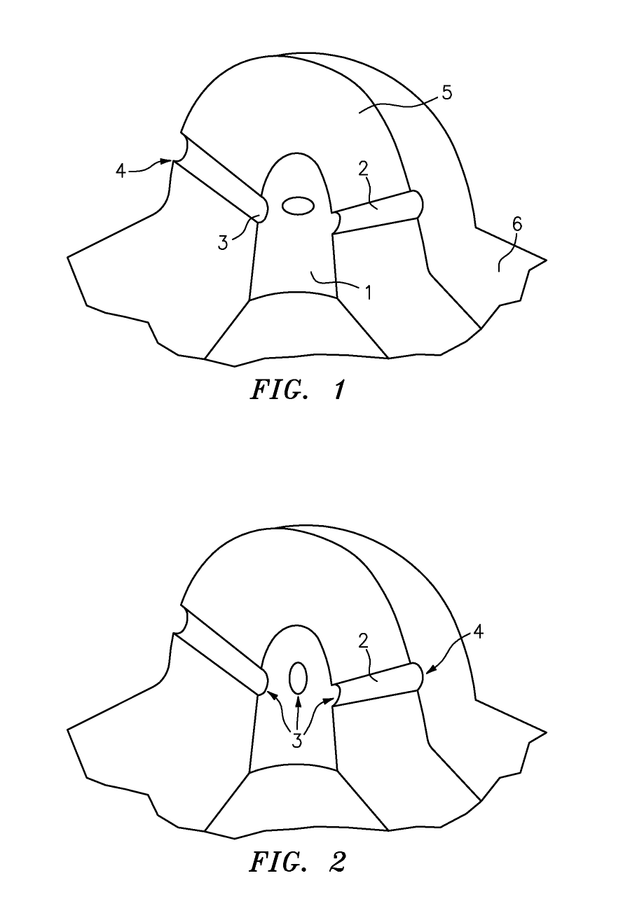

In the embodiment of the first aspect of the present invention presented in FIGS. 1 and 2, the spray holes each display a non-circular spray hole entrance 3. By means of the non-circular realization of the spray hole entrance 3 and the appropriate orientation of the spray hole entrances, the stresses acting in the area of the nozzle body 5 can be adjusted. In particular all the spray hole entrances display the same non-circular form and the same orientation with regard to the long axis of the blind hole or seat hole 1. The spray hole exits 4 of the spray holes 2 are in contrast circular, so as to achieve a normal fuel spray cone.

In both embodiments shown in FIGS. 1 and 2, the spray hole entrances are each elliptical in shape. The longer axis of symmetry of the elliptical form of the spray hole entrance is oriented according to the stresses acting on it (circumferential or axial stress), whereby the cross-sectional surface of the ellipse does not fall short of the required minimum cross-sectional surface.

As shown in FIG. 1, with dominant circumferential stress in the blind hole or seat hole 1, the ellipse is horizontally disposed. The ellipse is horizontally disposed when the longer axis of symmetry of the ellipse runs in a plane which lies perpendicular to the long axis of the blind hole or seat hole 1 or the nozzle body 5.

By this means a lesser notch effect arises in the direction of the load than with the use of a circular cross section.

As shown in FIG. 2, with dominant axial stress in the blind hole or seat hole, in contrast, the ellipse is vertically disposed. In this arrangement, the longer axis of symmetry of the ellipse is oriented in the direction of the long axis of the nozzle. By this means a lesser notch effect arises in the load direction than with a circular cross section.

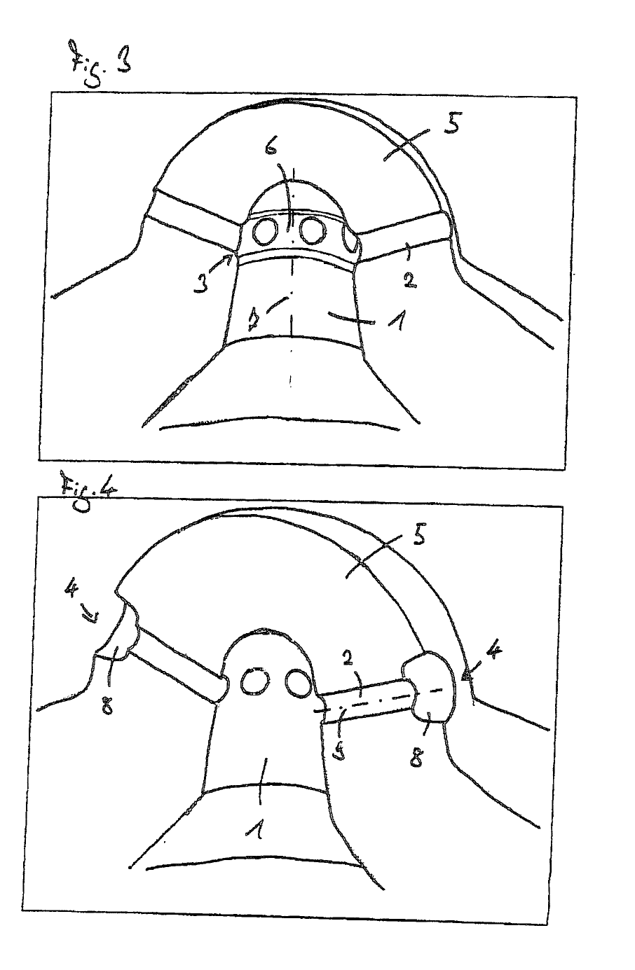

In FIG. 3 an embodiment of the second aspect of the present invention is presented. A groove 6 rotationally symmetrical to the blind hole axis 7 is provided in the area of the spray hole entrances 3. The groove 6 is provided in the side wall of the blind hole or seat hole 1 and displays an extension vertically which corresponds to that of the spray holes 2. The spray hole entrances 3 thereby are situated completely within the area of the groove 6.

The high notch stresses which arise with conventional intersecting bores are reduced by means of the rotationally symmetrical groove 6 in the blind hole or seat hole according to the invention, out of which the spray holes 2 lead.

FIG. 4 shows an embodiment of the third aspect of the present invention, according to which a counterbore 8 is provided at each spray hole exit 4. In the embodiment the counterbore 8 is made rotationally symmetrical to the spray hole axis 9. In particular the counterbore shows a U-shaped profile. According to the third aspect of the present invention it is possible to increase the thickness of the nozzle body 5 along the spray hole axis, without increasing the length of the spray holes. This promotes fatigue strength at the spray hole entrance, with almost unchanged geometry of the spray cone.

In addition to the nozzle itself, the present invention further comprises a process for the production of a nozzle according to the first aspect of the present invention. In the manufacture of the spray holes an erosion wire is used, which by means of appropriate control wears a defined path in the space and thereby provides the non-circular cross section of the spray holes in the entrance area 3 as well as the circular cross section in the exit area 4. For this purpose a wire erosion apparatus is used, by which the path can be chosen as desired not only in a plane but also in depth.

The present invention in all three aspects increases the fatigue strength of the nozzle in the area of the intersecting bores of the blind hole or seat hole to the spray hole, without any significant effect on the geometry of the spray cone. In particular the nozzle is employed as a fuel injection nozzle.

1. Nozzle with a nozzle body (5) on the back of which a blind hole or seat hole (1) is arranged, wherein at least one spray hole (2) leads outward from the blind hole or seat hole (1), and the spray hole (2) in the area of the spray hole entrance (3) displays a non-circular cross section.

2. Nozzle according to claim 1, wherein the spray hole (2) in the area of the spray hole entrance (3) displays an oval cross section, in particular an elliptical cross section.

3. Nozzle according to claim 1, wherein the spray hole (2) in the area of the spray hole exit (4) displays a circular cross section.

4. Nozzle according to claim 1, wherein whereby several spray holes (2) are provided, which extend outward from the blind hole or seat hole (1), the non-circular cross sections of the spray holes all display the same orientation with regard to the long axis (7) of the blind hole or seat hole, and advantageously the longer axes of the apertures which form the spray holes (3) in the area of their spray hole entrances are oriented parallel or perpendicular to the long axis (7) of the blind hole or seat hole.

5. Nozzle with a nozzle body (5), on the back of which a blind hole or seat hole (1) is arranged, wherein several spray holes (2) extend out from the blind hole or seat hole (1), and the blind hole or seat hole (1) displays a groove (6), out of which the spray holes (2) lead.

6. Nozzle according to claim 5, wherein the groove (6) is disposed so as to be rotationally symmetrical to the long axis (7) of the blind hole or seat hole (1) and/or the spray holes (2) are disposed at the same level with regard to the long axis (7) of the blind hole or seat hole (1) and/or the spray holes (2) are regularly distributed on the circumference of the groove.

7. Nozzle with a nozzle body (5), on the back of which a blind hole or seat hole (1) is arranged, wherein at least one spray hole (2) leads outward from the blind hole or seat hole (1), and the spray hole (2) is widened by a counterbore (8) at the spray hole exit (4).

8. Nozzle according to claim 7, wherein the counterbore (8) is made to be rotationally symmetrical to the spray hole axis (9).

9. Nozzle according to claim 1, comprising several spray holes (2) extending out from the blind hole or seat hole (1), and the blind hole or seat hole (1) displaying a groove (6), out of which the spray holes (2) lead.

10. Nozzle according to claim 5, comprising at least one spray hole (2) leading outwardly from the blind hole or seat hole (1), and the spray hole (2) being widened by a counterbore (8) at the spray hole exit (4).

11. Nozzle according to claim 1, wherein several spray holes (2) are provided, which lead outward from the blind hole or seat hole (1), and the long axes (9) of the spray holes advantageously extend radially outwards in an acute angle to the long axis (7) of the blind hole or seat hole (1).

12. Nozzle according to claim 1, wherein the nozzle body (5) and/or the blind hole or seat hole (1) are arranged to be rotationally symmetrical.

13. Nozzle according to claim 1, wherein the nozzle body (5) displays an advantageously dome-shaped elevation, on the back of which the blind hole or seat hole (1) is arranged, and several spray holes lead radially outward from the blind hole or seat hole (1) to the perimeter of the elevation.

14. Combustion engine with a nozzle according to claim 1 for the injection of fuel.

15. Process for the production of a nozzle according to claim 1, wherein the non-circular cross section of the spray holes (2) in the area of the spray hole entrance (3) is produced with an erosion wire, which during the production of the spray hole wears a path in the space corresponding to the non-circular cross section of the spray hole.

16. Nozzle according to claim 2, wherein the spray hole (2) in the area of the spray hole exit (4) displays a circular cross section.

17. Nozzle according to claim 16, wherein several spray holes (2) are provided, which extend outward from the blind hole or seat hole (1), the non-circular cross sections of the spray holes all display the same orientation with regard to the long axis (7) of the blind hole or seat hole, and advantageously the longer axes of the apertures which form the spray holes (3) in the area of their spray hole entrances are oriented parallel or perpendicular to the long axis (7) of the blind hole or seat hole.

18. Nozzle according to claim 3, wherein several spray holes (2) are provided, which extend outward from the blind hole or seat hole (1), the non-circular cross sections of the spray holes all display the same orientation with regard to the long axis (7) of the blind hole or seat hole, and advantageously the longer axes of the apertures which form the spray holes (3) in the area of their spray hole entrances are oriented parallel or perpendicular to the long axis (7) of the blind hole or seat hole.

19. Nozzle according to claim 2, wherein several spray holes (2) are provided, which extend outward from the blind hole or seat hole (1), the non-circular cross sections of the spray holes all display the same orientation with regard to the long axis (7) of the blind hole or seat hole, and advantageously the longer axes of the apertures which form the spray holes (3) in the area of their spray hole entrances are oriented parallel or perpendicular to the long axis (7) of the blind hole or seat hole.

20. Nozzle according to claim 1, comprising at least one spray hole (2) leading outwardly from the blind hole or seat hole (1), and the spray hole (2) being widened by a counterbore (8) at the spray hole exit (4).
